(19) United States
(12) Patent Application Publication
(10) Pub. No.: US 2015/0185114 A1
(43) Pub. Date: Jul. 2, 2015

(54) SPECIMEN PROCESSING DEVICE

(71) Applicant: ABON BIOPHARM (HANGZHOU) CO., LTD., Hangzhou (CN)

(72) Inventors: Jianfeng Wang, Hangzhou (CN); Jie Liu, Hangzhou (CN)

(73) Assignee: ABON BIOPHARM (HANGZHOU) CO., LTD., Hangzhou (CN)

(21) Appl. No.: 14/416,557

(22) PCT Filed: Jul. 16, 2013
(86) PCT No.: PCT/CN2013/079480

§ 371 Date: Jan. 22, 2015

(30) Foreign Application Priority Data
Jul. 23, 2012 (CN) 201210255422.4

(51) Int. Cl. G01N 1/10

(52) U.S. Cl. CPC G01N 1/10

(57) ABSTRACT

This invention provides a device, comprising a specimen chamber, a fluid flow control device and a boosting device; wherein the specimen chamber is connected with the fluid flow control device; the boosting device is used to increase pressure inside the specimen chamber. As the pressure inside the specimen chamber is higher than ambient pressure, fluid can smoothly flow out of the specimen chamber; in particular, when the specimen quantity is limited, pressure inside the specimen chamber can ensure flux and flow rate of the fluid, and thereby further guarantee the quantity of specimens to be tested and the testing accuracy; moreover, increased pressure enables specimens to flow out of the specimen chamber at a high speed, which is favorable for improvement of specimen processing efficiency and saving of overall testing time. This invention is also available for integration with collecting and testing devices to form a device integrating specimen collection, processing and testing. This device is light and easy for transport or carrying, which is especially suitable for household use.

### FIELD OF THE INVENTION

This invention is related to a specimen processing device, in particular to a device for pretreatment of specimens prior to test and a specimen processing method with the said device.

### BACKGROUND

Various specimen collection and extraction testing devices for clinical or household use are described in relevant literatures. Such testing devices make use of any collection tool to acquire and transfer specimens to the vessel, which can transfer specimens as extracted from the collection device to the testing element for determination of existence of certain substance, such as test for analyte. Such devices can be used for target classification, including test for medical and biological compounds, such as glucose or hormone, antibody or pathogen. Normally, specimens to be tested are in various forms, such as solid, semi solid, liquid or gas, which are unavailable for test or satisfactory test at the original state; it is normally necessary to proceed with pretreatment to such specimens to change their physical or chemical properties; for instance, it is applicable to dilute or buffer such specimens with buffer solution before test.

### SUMMARY OF THE INVENTION

The problem to be settled by the present invention is to provide a device that can increase the flux of fluid specimen flowing out of the specimen chamber after treatment or storage in the device, especially flux of limited specimens, and the time required for flowing out of the device; it aims to ensure the accuracy of further test, improve testing efficiency and shorten the testing time. Such device is available for treatment of specimens to be tested or storage of fluid specimens.

The problem to be settled by the present invention is to provide a device that can increase the flux of fluid specimen flowing out of the specimen chamber after treatment or storage in the device, especially flux of limited specimens, and the time required for flowing out of the device; it aims to ensure the accuracy of further test, improve testing efficiency and shorten the testing time. Such device is available for treatment of specimens to be tested or storage of fluid specimens.

In one aspect, this invention provides a device, comprising a specimen chamber for collection, treatment or storage of specimens, a fluid flow control device and a device used to increase pressure inside the specimen chamber; wherein, specimen chamber is connected with the fluid flow control device. In a preferred embodiment, increased pressure inside the specimen chamber impels the fluid to flow out of the specimen chamber via the fluid flow control device. Such specimen is used for collection, processing and storage of fluid specimens or any two combined functions of the three. Such functions are described in details thereinafter.

In another preferred embodiment, the fluid flow control device is provided with a position 1 and a position 2; when the device is at position 1, the specimen chamber is isolated from outside; when it is at the position 2, increased pressure will make the fluid specimen flow out of the specimen chamber. In a more preferred embodiment, pressure inside the specimen chamber is to be increased when the fluid flow control device is at the position 1; whereas increased pressure will impel partial fluid to flow out of the specimen chamber when the fluid flow control device is at the position 2.

In another preferred embodiment, the boosting device is to increase the pressure inside the specimen chamber when specimens come into it; once the fluid flow control device is opened, increased pressure will impel partial specimens to flow out of the specimen chamber.

In some preferred embodiments, the specimen chamber comprises an opening 1 and an opening 2, wherein the opening 1 is used to collect specimens; whereas the opening 2 is connected with fluid flow control device. In a more preferred embodiment, opening 1 of the specimen chamber is coupled with the boosting device to increase pressure inside the specimen chamber.

In another preferred embodiment, the fluid flow control device can maintain the sealed or non-sealed status of the specimen chamber from outside. The boosting device aims to increase the pressure inside the specimen chamber after flow-in of specimens; when specimens as processed or are to be tested, the fluid flow control device will enable the specimen chamber to interconnect with outside (non-sealed status); under such circumstance, fluid inside the chamber will flow out as the pressure inside it is higher than the ambient pressure.

Pressure inside the specimen chamber can maintain the flux and flow rate of the fluid even if specimen quantity is so limited; meanwhile, it can also enable most of specimens to flow out of the specimen chamber under the action of the pressure. This invention is expected to seal up the specimen chamber, and increase the pressure inside it through the coordination between the fluid flow control device and the boosting device, and thereby enable fluid to flow out of the specimen chamber when the specimen chamber is opened. In this way, flux and flow rate of specimens flowing out of the chamber are higher than that under the normal pressure, which can further ensure the quantity of specimens for test and the testing accuracy in addition to reduced testing time and improved testing efficiency.

Furthermore, the “boosting device” of this invention can increase pressure inside the specimen chamber. In particular, such function is realized by a piston structure; alternatively, pressure inside the chamber is to be increased by the gas as generated through chemical reaction of fluid inside the specimen chamber. In a preferred embodiment, sealing element seals up the specimen chamber, and forms a hermetic seal with its inner wall to increase pressure inside the specimen chamber through movement of sealing element inside it. In a preferred embodiment, the sealing element is used to seal up the opening receiving fluid specimens on one end of the specimen chamber; whereas the fluid flow control device is used to seal up or open the opening on the other end of the specimen chamber. Pressure inside the specimen chamber is to be increased once the opening on the other end is sealed up; whereas increased pressure will impel partial fluid to flow out of the specimen chamber once the other end is opened.

In the aforesaid preferred embodiments, such device also comprises a testing chamber and a testing element; the testing chamber is connected with the fluid flow control device; whereas the testing element is located inside the testing chamber. In a preferred embodiment, the testing chamber is communicated with the valve; whereas the valve controls the fluid flowing into the testing chamber from the specimen chamber. In a more preferred embodiment, increased pressure inside the specimen chamber impels partial fluid to flow into the testing chamber from the specimen chamber directly for contact with the testing element. In another preferred embodiment, the valve chamber is also connected with a specimen storing chamber; increased pressure inside the specimen chamber impels partial fluid flowing into the specimen chamber to further flow into the specimen storing chamber directly. Nevertheless, pressure as increased by the specimen chamber will impel fluid flowing into the specimen chamber to flow into the testing chamber and the storing chamber simultaneously.

In some other preferred embodiments, it is applicable to store reagent for processing of specimens in the specimen chamber in advance before specimens coming into the specimen chamber. Such reagent can be solution used to dilute specimens or wash off specimens affixed to the sampling vessel; however, it is also applicable to add and fully mix such reagents with specimens coming into the specimen chamber. Such reagents can be common buffer solutions or reagents or solutions for other purposes.

Nevertheless, it is applicable to store collected specimens in the specimen chamber before opening the fluid flow control device to make fluid specimens flow out of the specimen chamber in case of test or requisition of partial fluid specimens. It is applicable to increase pressure inside the specimen chamber to impel partial fluid to flow out of the specimen chamber automatically for direct test or experiment before opening the fluid flow control device.

In some other preferred embodiments, such device also comprises a cover used to seal up the opening for collection of specimens on one end of the specimen chamber. The cover is coupled with the specimen chamber in various forms, such as buckled and pressed couplings. In one embodiment, inside of the cover is provided with screw-in threads; whereas the specimen chamber is provided with corresponding receiving threads. In another embodiment, reagent for processing of specimens is to be prepared before use; for instance, buffer solution is to be put into the specimen chamber in advance; whereas the cover is to be located on the specimen receiving chamber to prevent leakage of buffer solution inside the chamber and specimens to be collected.

In a more preferred embodiment, the cover is used in combination with the boosting device; pressure inside the specimen chamber is to be increased simultaneously when the cover is covered on the opening of the specimen chamber. Sealing element independent of the cover can be selected as the boosting device; whereas a project part can be provided on the inner wall of the cover. Close the cover to enable the projected part inside it to contact with the sealing element once specimens come into the specimen chamber; once the cover is coupled with the opening of the specimen chamber, projected part inside the cover will push sealing element to move towards the bottom of the specimen chamber, and thereby compress the air, and increase pressure inside it.

In another embodiment, the said sealing element is attached to the cover. The sealing element is available for connection with the cover; similarly, the sealing element will also seal up the specimen chamber, and compress the air inside it when the cover is coupled with the specimen chamber. In a more preferred embodiment, the sealing element is located on the top inner wall of the cover; under such circumstance, the cover top up to the certain thickness can provide certain compressive force for air compression.

Specimen chamber of this invention aims to ensure adequate mixing of specimens with buffer solution, of which, structure is available for special design. For instance, it is applicable to provide back plate inside the chamber or use flexible extruding material to fabricate the specimen chamber. In an embodiment, central part of the specimen chamber is in funnel structure with diameter of upper part higher than that of the lower part; when the specimen collection bar attached with specimens are inserted into the specimen chamber, suction part of the collection bar is to be located at the lower part of the specimen chamber. Such lower chamber structure aims to ensure full submersion and absorption of the part by the buffer solution in the specimen chamber as well as adequate contact between specimens on the absorption part and the buffer solution, and thereby facilitate full processing of specimens.

In one aspect, this invention provides a device, comprising a specimen chamber for collection, processing or storage of specimens and a fluid flow control device; the specimen chamber is connected with the fluid flow control device, wherein partial specimen chamber is made of extruding material. In another preferred embodiment, the specimen chamber made of extruding material enables fluid specimen to flow out of it; in a further preferred embodiment, the specimen chamber made of extruding material aims to increase pressure inside it to impel fluid specimens flow out it; such pressurization mode aims to impose an external force on the extruding material to make it deformed. More particularly, increased pressure inside the specimen chamber impels the fluid inside it flow out via the fluid flow control device. Such specimen chamber is used to collect and process or store fluid specimens, or execute any two combined functions of the three. Such functions are described in details thereinafter.

Once specimens are located inside the specimen chamber, it is very important for solution inside the specimen chamber to flow into the next chamber for further operations. Specimen chamber of this invention is made of extruding material. “Extruding material” refers to the material that is to be deformed once external force is imposed on it. Accompanied by increase in the imposed force, deformation will become more and more significant. As the specimen chamber is made of extruding material, it is applicable to extrude it to alter its volume by imposing external force directly (such as pinching); in this way, pressure inside the specimen is to be increased; furthermore, increased pressure will enable liquid to flow out of the specimen chamber quickly; alternatively, if extrusion is imposed at the position of liquid inside the chamber, the liquid will be discharged under extrusion. In particular, space and volume of the specimen chamber are to be reduced under extrusion; comparatively speaking, pressure inside the specimen chamber is to be increased; furthermore, if the specimen chamber is filled with such liquids as specimen or buffer solution or the mixture of the two, volume of the specimen chamber is to be decreased through extrusion of the specimen chamber and liquids inside it; consequently, pressure inside the chamber is to be increased and/or liquids inside it is to be discharged. Nevertheless, it is applicable to impose an external force on the chamber to eliminate the external force imposed previous, and thereby recover original profile of deformed chamber.

In a still further embodiment, such specimen chamber is made of such extruding and elastic materials as rubber, plastics, PVC, PP, silica gel and so on. In a preferred embodiment, the specimen chamber is provided with an elastic hose; in a more preferred embodiment, the specimen chamber is made of flexible plastic material. To facilitate observation of quantity of liquid inside the specimen chamber, specimen chamber can be made of transparent material; “transparency” refers to light transmission material that enable people to see objects behind it with naked eyes under normal indoor illumination; furthermore, operators of this device can see the quantity of specimens below the transparent window or testing results. In a preferred embodiment, the specimen chamber is made of transparent flexible plastics.

In another preferred embodiment, the fluid flow control device is provided with a position 1 and a position 2; when it is at the position 1, fluid inside it is unlikely to flow out; when it is at the position 2, fluid will be able to flow into the specimen chamber. In a more preferred embodiment, when the fluid flow control device is at the position 1, pressure inside it is to be increased; when it is at the position 2, increased pressure will impel partial specimens flow out of the specimen chamber.

“Fluid flow control device” of this invention can control communication of specimen chamber and fluid insides it with outside. The function of such device can be realized by various means. Such device is provided with numerous approaches to realize this function, such as extractable back plate located at one port of the specimen chamber. It is applicable to extract the back plate to ensure communication of the specimen chamber and liquid inside it with outside. Alternatively, it is also applicable to use film to seal up one port of the specimen chamber. Pierce the film to enable fluid specimen flow out if necessary. In an embodiment, this fluid flow control device can be a valve connected with the specimen chamber; it is applicable to control communication between the specimen chamber and outside through opening and closing the valve. In a particular embodiment, the valve is provided with a position 1 and a position 2 in the valve chamber; when the valve is at the position 1, namely the OFF position, specimen chamber is to be sealed up by the valve; when the valve is at the position 2, namely ON position, the specimen chamber is to be communicated with the valve, and the fluid inside the specimen chamber will flow out. In a more preferred embodiment, when the valve is at the position 1, pressure inside the specimen chamber is to be increased by the boosting device; when the valve is at the position 2, increased pressure will discharge the fluid out of the specimen chamber. In a preferred embodiment, the specimen chamber comprises openings on both ends; the fluid flow control device will seal up or open the opening on one end; whereas that on the other end is to be used to receive fluid specimens. For instance, the opening 1 is used to receive specimens; whereas the opening 2 is used to connect the valve with valve chamber to control fluid flowing out of the specimen chamber.

In a preferred embodiment, the opening on one end of the specimen chamber is communicated with a valve chamber; such valve chamber is used to collect a valve; external surface of the valve is sealed up with inner wall of the valve chamber through linear contact; in other words, external surface of the valve is provided with projected lines for linear contact with inner wall of the valve chamber. Alternatively, projected lines on the external surface of the valve chamber can be in linear contact with outer wall of the valve. In this way, sealing performance between the valve and valve chamber can be ensured; this can maintain the sealing performance of specimen chamber, and prevent leakage of specimens inside the specimen chamber; in particular, fluid specimens inside the specimen chamber will not flow out when the pressure inside the specimen chamber is increased. This is favorable for better control of fluid inside the specimen chamber. In view of certain pressure inside the specimen chamber of this invention, it is of vital importance to ensure perfect sealing performance; meanwhile, it is also important to ensure satisfactory sealing performance in order to guarantee testing accuracy, and prevent leakage of specimens in small quantity.

Furthermore, “some other boosting devices” of this invention can increase the pressure inside the enclosed specimen chamber. In particular, such functions can be realized by a piston structure; alternatively, it is applicable to increase pressure inside the chamber with the help of the gas as generated by chemical reaction of liquids inside the specimen chamber. In a preferred embodiment, sealing element is used to seal up the specimen chamber to form a hermetic seal with inner wall of the specimen chamber; the sealing element can also be used to seal up one opening receiving fluid specimens on the specimen chamber; whereas fluid flow control device can seal up or open the other opening on the specimen chamber. When the opening on the other end is sealed up, pressure inside the specimen chamber is to be increased; whereas when the other end is opened, increased pressure will force partial fluid to flow out of the specimen chamber.

In the aforesaid preferred embodiments, such device also comprises a testing chamber and a testing element; the testing chamber is connected with the fluid flow control device; whereas the testing element is located inside the testing chamber. In a preferred embodiment, the testing chamber is communicated with the valve; whereas the valve controls the fluid flowing into the testing chamber from the specimen chamber. In a more preferred embodiment, increased pressure inside the specimen chamber impels partial fluid to flow into the testing chamber from the specimen chamber directly for contact with the testing element. In another embodiment, the valve chamber is also connected with a specimen storing chamber; increased pressure inside the specimen chamber impels partial fluid flowing into the specimen chamber to further flow into the specimen storing chamber directly. Nevertheless, pressure as increased by the specimen chamber will impel fluid flowing out of the specimen chamber to flow into the testing and storing cavities simultaneously.

In some other embodiments, it is applicable to store reagent for processing of specimens in the specimen chamber in advance before specimens coming into the specimen chamber. Such reagent can be solution used to dilute specimens or wash off specimens affixed to the sampling vessel; however, it is also applicable to add and fully mix such reagents with specimens coming into the specimen chamber. Such reagents can be common buffer solutions or reagents or solutions for other purposes.

Nevertheless, it is applicable to store collected specimens in the specimen chamber before opening the fluid flow control device to make fluid specimens flow out of the specimen chamber in case of test or requisition of partial fluid specimens. It is applicable to increase pressure inside the specimen chamber to impel partial fluid to flow out of the specimen chamber automatically for direct test or experiment before opening the fluid flow control device.

In some other preferred embodiments, such device also comprises a cover used to seal up the opening for collection of specimens on one end of the specimen chamber. The cover is coupled with the specimen chamber in various forms, such as buckled and pressed couplings. In one embodiment, inside of the cover is provided with screw-in threads; whereas the specimen chamber is provided with corresponding receiving threads. In another embodiment, reagent for processing of specimens is to be prepared before use; for instance, buffer solution is to be put into the specimen chamber in advance; whereas the cover is to be located on the specimen receiving chamber to prevent leakage of buffer solution inside the chamber and specimens to be collected.

In a more preferred embodiment, the cover is used in combination with the boosting device; pressure inside the specimen chamber is to be increased simultaneously when the cover is covered on the opening of the specimen chamber. Sealing element independent of the cover can be selected as the boosting device; whereas a project part can be provided on the inner wall of the cover. Close the cover to enable the projected part inside it to contact with the sealing element once specimens come into the specimen chamber; once the cover is coupled with the opening of the specimen chamber, projected part inside the cover will push sealing element to move towards the bottom of the specimen chamber, and thereby compress the air, and increase pressure inside it.

In another embodiment, the said sealing element is attached to the cover. The sealing element is available for connection with the cover; similarly, the sealing element will also seal up the specimen chamber, and compress the air inside it when the cover is coupled with the specimen chamber. In a more preferred embodiment, the sealing element is located on the top inner wall of the cover; under such circumstance, the cover top up to the certain thickness can provide certain compressive force for air compression.

Specimen chamber of this invention aims to ensure adequate mixing of specimens with buffer solution, of which, structure is available for special design. For instance, it is applicable to provide back plate inside the chamber or use flexible extruding material to fabricate the specimen chamber. In an embodiment, central part of the specimen chamber is in funnel structure with diameter of upper part higher than that of the lower part; when the specimen collection bar attached with specimens are inserted into the specimen chamber, suction part of the collection bar is to be located at the lower part of the specimen chamber. Such lower chamber structure aims to ensure full submersion and absorption of the part by the buffer solution in the specimen chamber as well as adequate contact between specimens on the absorption part and the buffer solution, and thereby facilitate full processing of specimens.

Meanwhile, this invention also provides a specimen processing kit, comprising aforesaid specimen devices, a box body and a specimen collection bar. The box body aims to connect the specimen chamber with the fluid flow control device. Furthermore, this specimen processing kit also comprises a testing chamber and a testing element inside the kit. Specimen collection bar used to collect specimens of objects tested; such specimens are in solid, semi solid, liquefied or gaseous forms. Put the sampled specimen collection bar into the specimen chamber, and add buffer solution before using boosting device to increase pressure inside the specimen chamber. For instance, it is applicable to put the sealing element into the specimen chamber to seal up and compress air inside it, or put on the cover attached with sealing element directly. Nevertheless, it is also applicable to add buffer solution into the specimen chamber in advance before using this device. After that, open any fluid flow control device, such as valve to open the specimen chamber. In an embodiment, specimen chamber is connected with the testing chamber via the valve chamber; owing to pressure inside the specimen chamber, process specimens will flow out of the specimen chamber for contact with the testing chamber to complete the test.

In some embodiments, height of the specimen chamber exceeds the length of specimen collection bar, which can contain the whole specimen collection bar. Furthermore, height of lower specimen chamber exceeds or equals to that of the absorption element of specimen collection bar, which can fully locate the absorption element into the lower chamber.

Furthermore, this invention also provides a method for processing and discharging of specimens, wherein specimens and/or reagent for processing of specimens are to be added into the specimen chamber; extrude the specimen chamber to increase pressure in it; establish a link between the specimen chamber and outside; increase pressure to force specimens and/or specimen processing reagent or the mixture of the two to flow out of the specimen chamber.

In a preferred embodiment, the fluid flow control device is used to control fluid flowing into the specimen chamber. In a further preferred embodiment, the specimen chamber is provided with openings on both ends; fluid control device is connected with one opening; whereas the boosting device aims to increase the pressure through the other opening.

In some embodiments, such fluid flow control devices as extractable back plate and film that can be pierced, are used to control communication between the specimen chamber and external objects. In a specific embodiment, the valve is used to control communication between the specimen chamber and outside.

In some other embodiments, another boosting device is used to increase pressure inside the specimen chamber; for instance, it is applicable to increase the pressure with the help of piston device or chemical reaction of liquid that increases the volume of gas inside the specimen chamber; in a preferred embodiment, sealing element is used to seal up the specimen chamber, and compress gas inside it to increase the pressure; the increased pressure enables the mixed specimen fluid to flow out.

In some embodiments, buffer solution can be added into the specimen chamber before or after specimens flowing into the specimen chamber.

In some embodiments, it is applicable to use swab on the specimen collection bar to collect specimens before putting the specimen collection bar affixed with specimens into the specimen chamber.

In some other embodiments, fluid flowing out of the specimen chamber is to be in contact with the testing element to test specimens or their mixture.

In another aspect, this invention provides a specimen processing method, comprising addition of specimens and/or specimen processing reagent into one specimen chamber, wherein partial specimen chamber is made of extruding material; pressure inside the specimen chamber is to be increased through extrusion of the specimen chamber; specimen chamber is to be communicated with outside; whereas increased pressure will force fluid specimens to flow out of the specimen chamber.

In a preferred embodiment, the valve is used to control communication between the specimen chamber and outside.

In a preferred embodiment, pressure inside the specimen chamber is to be increased when the valve is at the position 1; whereas increase pressure will force fluid specimens to flow from the valve into the specimen chamber when the valve is at the position 2.

In a preferred embodiment, it is applicable to add specimen processing reagent into the specimen chamber before or after specimens flowing into the specimen chamber.

In a preferred embodiment, fluid specimens flowing out of the specimen chamber are to be in contact with the testing element.

### BENEFICIAL EFFECT

As specimen chamber of this invention is available for extrusion, it is applicable to extrude it to increase the pressure inside it or directly extrude to impel liquid inside it to flow out eventually. Such operation can maintain the flux and flow rate of specimens in small quantity, and thereby ensure the quantity of specimens for further test and testing accuracy. Meanwhile, increased pressure can make specimens flow out of the specimen chamber at a high speed, improve specimen processing efficiency, and save the total time as required by the test. This invention is also available for coupling with collection and testing devices to integrate such functions as collection, processing and testing. This device is light and easy for transport or carrying, which is especially favorable for household application.

### DRAWINGS

FIG. 1 is a solid diagram for the device of this invention;

FIG. 2 is a structural diagram for the valve of this device;

FIG. 3 is a structural diagram for the valve at another angle;

FIG. 4 is a section of the valve;

FIG. 5 is a section of the valve in another orientation

FIG. 6 is a structural breakdown drawing for the specimen chamber cover of this device;

FIG. 7 is a structural breakdown drawing of the specimen chamber of this device;

FIG. 8-10 is a process diagram for coupling between the sealing element cover and the specimen chamber;

FIG. 11 is a solid diagram for a specimen processing box of this device (the valve is at OFF status, which is located at the position 1 inside the valve chamber);

FIG. 12 is a diagram for the valve on the box of this device at ON status (the valve is at the position 2 inside the valve chamber);

FIG. 13 is a structural breakdown drawing of the box of this invention;

FIGS. 14-17 are diagrams for the operation procedures of the box of this invention.

### DESCRIPTION OF DRAWING MARKS

Specimen chamber 100, specimen chamber opening (opening 1) 101, specimen chamber bottom 102, upper specimen chamber 103, lower specimen chamber 104, inner wall of specimen chamber 106, opening at the specimen chamber bottom (the opening 2) 107, projected structure at the opening 1 of the specimen chamber 109, specimen chamber window 108, valve 200, valve switch 201, line on the external surface of the valve 203a, 203b, 203c, 203d and 203e, valve chamber 206, channel between the valve chamber and testing chamber 205, valve channel 800, valve holes 801 and 802, external surface of the valves 207, 2071, 2072 and 2073, inner wall of valve city 208, specimen testing chamber 300, testing element 301, absorption area of testing element 3011, filter 302, testing chamber window 307, sealing element 400, cover 500, cover top 501, cover body 502, box body 600, upper box cover 601, lower box cover 602, sample collection bar 700, holding part of collection bar 701 and absorption part 702.

Further description of structure of the liquefied specimen collection device or technical terms used is stated as follows:

### Specimen

“Specimen” in this invention refers to any substance to be tested for determination of the concentration of analyzing and analyzed substances or any substance used to determine the quantity of any analyzed substance as contained in one or more specimens or any substance subject to quantitative evaluation. Such specimen can be fluid specimen, such as liquefied one. Liquefied specimen can be any aqueous specimen, such as seawater, river water or domestic water, municipal water or industrial water resource, runoff or sewage; such specimen can also be any food specimen, such as milk and wine. Mucus, semi solid or solid specimen can also used to fabricate such specimens as liquid, eluate, suspensoid or extract. For instance, specimens for throat or genital organ can be fabricated through soaking in the liquid. Such specimens may comprise liquefied, solid and gaseous mixtures or any relevant mixtures, such as diluents or cell suspensoid in the solution. Such specimens also comprise biological substances, such as cells, microbes, organelles and biochemical compounds. Liquefied specimens can be extracted from the soil, stool, organism, organ, biological fluid or solid, semi solid and extremely viscous substances, such as non-liquefied natural specimens. For instance, such solid or semi solid specimens are available for mixing with appropriate diluents. Such specimens can be fabricated into liquefied specimens through soaking, freezing and thawing or other extractions. Residual granular substances can be eliminated with such conventional methods as filter or sedimentation.

### Testing Element

“Testing element” refers to an element available for test. In an embodiment, the testing element is a test bar. Such test bar may comprise a substance pair of specific binding for immune analysis. The test bar can be a chemical test bar used to judge results through variation to the color or other signals upon completion of the test. Specimens available for testing of this invention including but not limited to body fluid and specimens extracted from biological tissues or body fluid. For instance, such specimens can be saliva, blood, serum, plasma, urine, excrement, spinal fluid, mucilage and tissue. The testing element is not limited to one; two or more testing elements can be located within the same testing device simultaneously for testing of different constituents in the specimen.

### Specimen Collection Bar

This invention also provides a specimen collection bar 700. In an embodiment, the specimen collection bar 700 is provided with an absorption element 702 and a holding part 701. The absorption element 702 is normally fabricated with conventional medical sponge or foamed plastics used in this field. However, the absorption element can be made of many other materials, such as cotton or paper or any material available for water absorption. Specimen collector can be soaked in the solution that can stimulate patient tested to secret saliva. In this way, collection of saliva will be become easier when the collector is put into the mouth of the patient. The holding part is normally made of rigid material, which is favorable for operation of the absorption element. The holding part can be made of common materials in this field, such as plastics, wood, metal or carton. In a preferred embodiment, the specimen collection bar belongs to the flocked swab as described in European Patents numbered EP1893740B1 and EP1608268B1.

### Specific Embodiments

According to detailed description thereafter, drawings and corresponding literal descriptions are expected to describe potential specific embodiments of this invention through illustration. We will not exclude any other particular embodiment of this invention as covered by claims.

The device as provided by a particular embodiment of this invention comprises a specimen chamber 100, a fluid flow control device and a device used to increase pressure inside the specimen chamber, wherein the specimen chamber 100 is connected with the fluid flow control device.

Partial specimen chamber 100 is made of extruding flexible plastics available for elastic compression; however, such specimen chamber can be made of other extruding material only on condition that is available for extrusion; in other words, the specimen chamber can be compressed to narrow the space inside it. Such materials comprise elastic plastics, PP, PVC as well as rubber and silica gel. Nevertheless, such specimen chamber can be made of transparent material to ensure precise command of specific conditions inside it. In some other embodiments, the whole chamber is made of extruding flexible plastics available for elastic compression.

In some particular embodiments, the fluid flow control device is a structure of valve 200. This valve is identical to common ones in the industry in terms of structure and functions; in other words, this valve is not communicated the connected part when it is at OFF status, which is to be communicated with all or partial parts connected with it. Various valves can be used to the said device of this invention, such as rotary valve, stopcock, ball valve, needle valve, reversing valve or piston valve, gate valve, directional valve and so on.

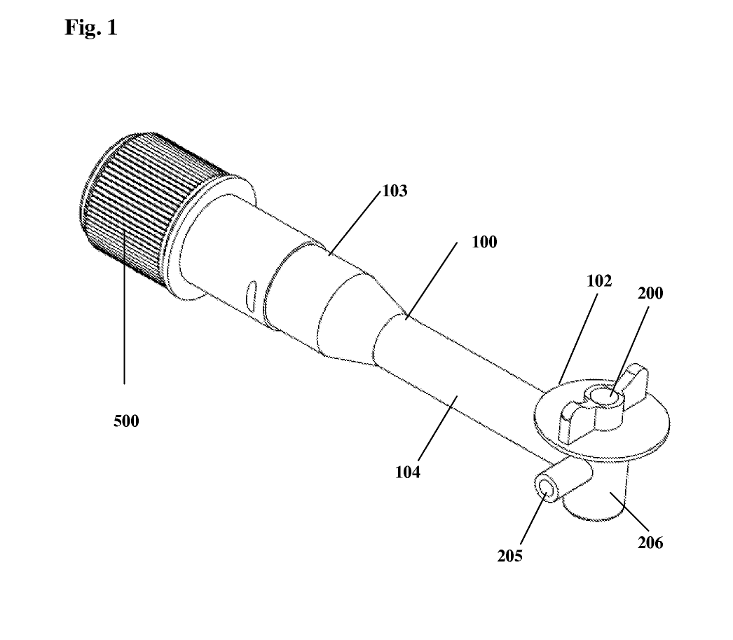

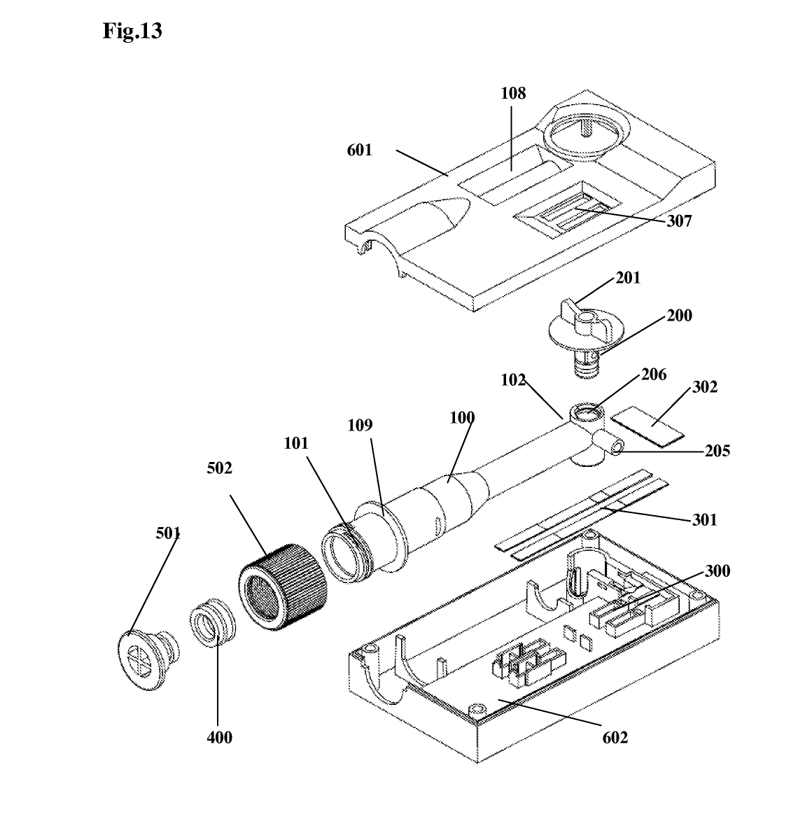

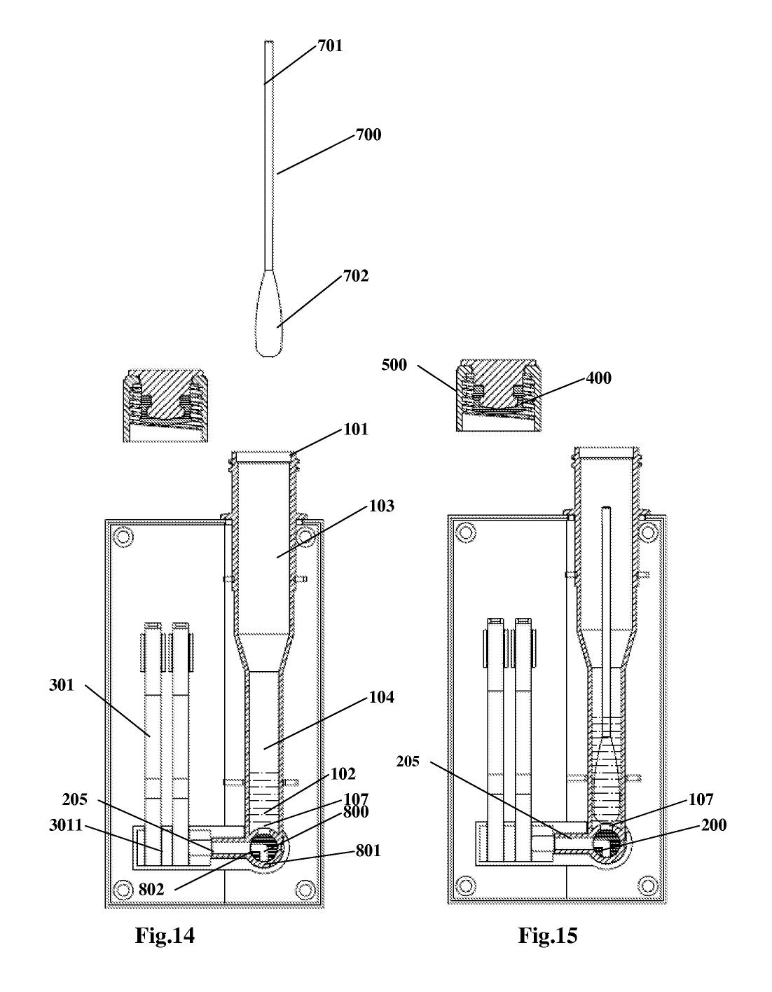

In a particular embodiment, specimen chamber 100 as shown in FIG. 1 and FIG. 13 comprises a chamber opening 101 and a chamber bottom 102 and a chamber inner wall on one end; the chamber opening 101 is used to collect specimens; the valve chamber 206 is connected with the chamber bottom 102; the chamber bottom is provided with an opening 107 as communicated with the valve chamber. Valve 200 is located inside the valve chamber 206; valve 200 is provided with an ON and OFF position as controlled by the switch 201 on it. When the valve 200 is at OFF status or is located at the position 1 of the valve chamber 206 as shown in FIG. 14-16, opening 107 at the specimen chamber bottom is to be sealed up by the valve 200, which is not to be communicated with outside; when the valve 200 is opened or is at the position 2 of the valve chamber 206 as shown in FIG. 17, the specimen chamber 100 is to be communicated with outside through the opened valve 200. Particularly, the valve comprises a valve channel 800; when the valve 200 is opened, fluid inside the specimen chamber will flow into the valve channel 800 via the opening 107 before being discharged from the specimen chamber.

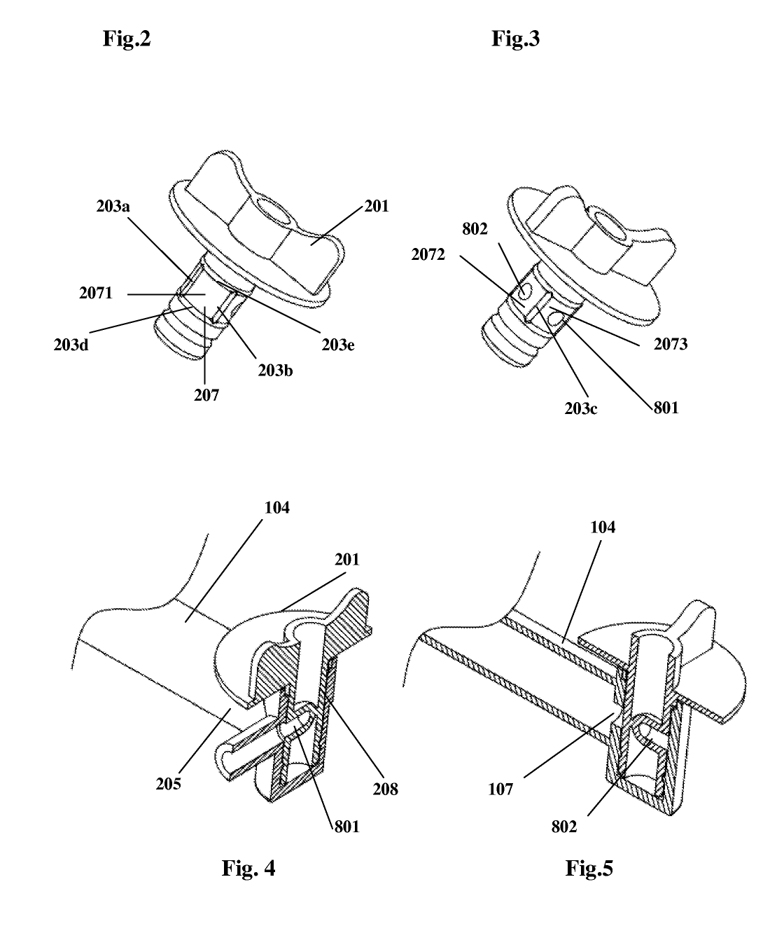

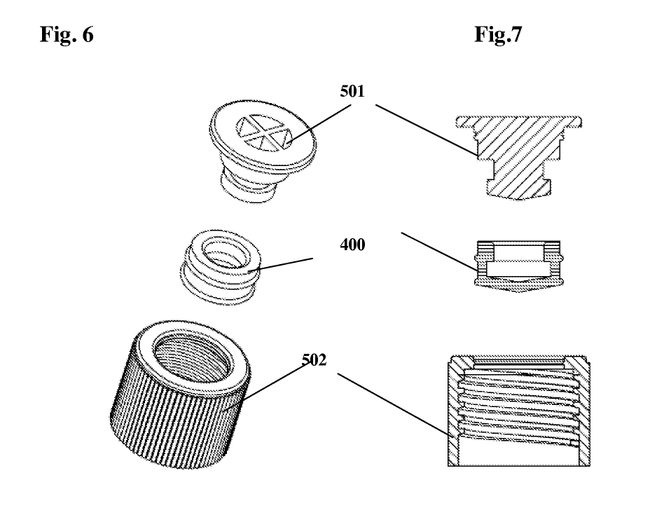

In a more preferred embodiment, the valve 200 is sealed up with the inner wall of the specimen chamber bottom 102 of the valve chamber 206 through linear contact to ensure the sealing performance of valve 200. In some more particular embodiment, the external surface 207 in contact with the contact surface of valve 200 is provided with a linear projection 203 as shown in FIGS. 2 and 3; whereas FIG. 3 is a diagram showing rotation of the valve as shown in FIG. 2 by 180° approximately; as shown in FIG. 2, there are altogether 5 linear projections; two loop lines 203d and 203e as shown in FIG. 2 are distributed on the external surface in circumferential direction; line 203a, 203b and 203b (as shown in FIG. 3) are vertical to the aforesaid two loop lines; the valve 200 is in contact with the inner wall 208 of the valve chamber 206 through the 5 linear projections to form a linear contact. In this way, its contact area is to be reduced significantly as compared with that as formed through direct contact between the external surface of valve 200 and the inner surface of valve chamber 206; as a result of it, the possibility for leakage of fluid through the contact surface is to be reduced significantly; moreover, owing to the linear contact, face-to-face friction is to be transformed into the line-to-face one to the extent of reducing the friction force; consequently, the force as required by rotation of the valve is to be reduced to ensure easier control of the valve.

Furthermore, such 5 linear projections divide the external surface of valve 200 into 3 parts, namely 2071, 2072 and 2073 on the surface A, B and C respectively. Surface B 2072 and C 2073 are provided with hole B 802 and C 801 respectively; hole B 802 and C 801 are in communication with internal part of the valve 200 to form a valve channel 800. As surface A is not provided with communicated holes during operation, fluid will not flow into and stay in this area; this can effectively facilitate more fluids to flow out, especially when the quantity of specimens is so limited.

The opening 107 on one end of the specimen chamber is to be sealed up by the valve 200 at the position 1 during operation; the opening 107 on one end of the specimen chamber is to be opened to connect with the valve channel when the valve 200 is at the position 2; whereas fluid specimens will flow out of the specimen chamber through valve channel 800.

The approach for fluid specimens to flow out of the specimen chamber is to increase pressure inside the specimen chamber; increased pressure will force fluid specimens flow out of the specimen chamber. For instance, pressure inside the specimen chamber is to be increased when the valve 200 is at the position 1; this way for increase of pressure can facilitate the specimen chamber made of extruding material to impose an external force for deformation. Increased pressure will force fluid specimens to flow out of the specimen chamber 100 through the valve channel 800 when the valve 200 is at the position 2.

Specific approaches for increase of pressure are to be described in details in the following particular embodiments:

In some embodiments, sealing element 400 with sealing performance can be used as the boosting device; the sealing element can seal up the specimen chamber 100 at the chamber port 101 when it comes into the specimen chamber 100; under such circumstance, a hermetic seal is to be formed through contact between the sealing element 400 and inner wall of the specimen chamber 100. After that, the sealing element 400 will move to the chamber bottom 102 along the chamber opening 101 to compress the air inside the chamber, and thereby form a certain pressure.

Partial specimens, such as solid or semi solid specimens of this invention are to be diluted or neutralized with buffer solution; even more, partial specimens as affixed to the specimen collection device are to be washed off with buffer solution; therefore, it is applicable to add buffer solution with aforesaid functions into the specimen chamber 100, such as PH buffer solution, anti-oxidation solution or anti-absorption solution, protein solution and so on. Such solutions can be added before or after specimens coming into the specimen chamber 100. In a particular embodiment, buffer solution can be stored inside the specimen chamber 100 in advance. To ensure more accurate testing results, it is applicable to stipulate certain requirements for the dosage of buffer solution according to properties of specimens and testing conditions. Normally, it is necessary to maintain a certain proportion between the buffer solution and specimen quantity. In an embodiment, the volume ratio between the buffer solution and specimen quantity is 1:1. In a more particular embodiment, volume of the buffer solution is 1 liter.

In some embodiments, this device also comprises a cover 500 as shown in FIGS. 1 and 13. The cover 500 and one end of the specimen chamber 100 are used to accept the specimen opening 101 to form a seal; in this way, buffer solution can be more conveniently stored inside the specimen chamber 100 in advance (when the solution is involved). The specimen chamber 100 can be coupled with the cover 500 in various modes, such as piston or buckle or pressing and so on; leakage of buffer solution inside the chamber can be prevented once the two are properly coupled. In an embodiment, screw-in threads are provided inside the cover 500; whereas the opening 101 of the specimen chamber 100 is provided with corresponding receiving threads; the two are in threaded coupling.

In some other embodiments, the sealing element 400 can be used in combination with the cover 500. In an embodiment, inner top of the cover 500 is designed with a projected part; the projected part inside the cover is to be in contact with the sealing element 400 when the sealing element 400 is located inside the specimen chamber 100, and the cover 500 is closed during operation; once the cover 500 is coupled with the specimen chamber 100, the projected part will push the sealing element 400 to shift towards the specimen chamber bottom 102 to compress the air inside accompanied by the movement of the cover 500. In a further embodiment, the sealing element 400 is connected with the cover 500; for instance, the two are connected by a slim bar; when the specimen chamber 100 is sealed up by the cover 500, air inside the specimen chamber 100 is to be compressed by the sealing element 400 simultaneously.

In a preferred embodiment, the sealing element 400 is in supporting connection with the cover top 501, of which, the structure is as shown in breakdown drawings 6 and 7. The cover comprises a top 501 and a cover body 502. Inside of the cover top 501 as enclosed by the sealing element 400 is coupled with the cover body 502 to constitute an integral part. The cover top 501 has certain height to ensure compression of certain volume of air, and thereby obtain a certain pressure once the specimen chamber 100 is closed by the cover 500.

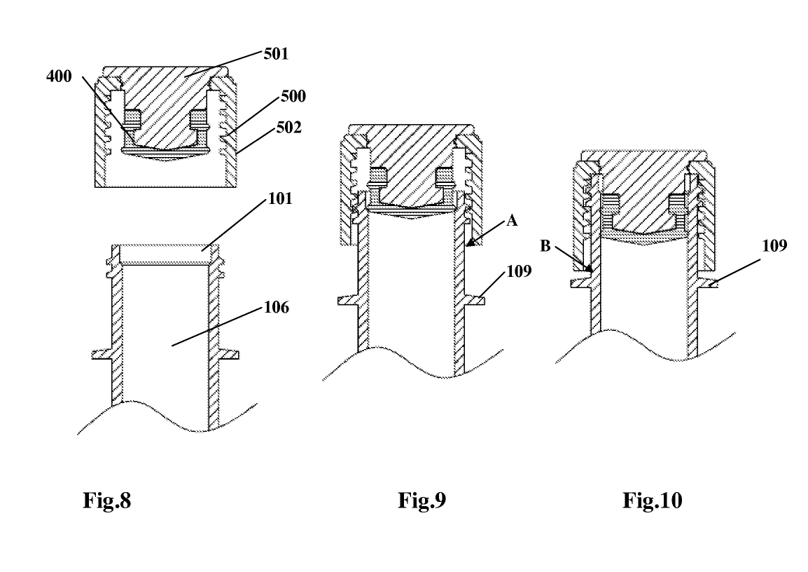

Pressure increase process during the coupling between the cover 500 and the specimen chamber 100 is as shown in FIGS. 8-10. As shown in FIG. 8, when the cover 500 is not coupled with the specimen chamber 100, there exists a certain gap to the inner wall of the cover after coupling between the sealing element 400 and the cover top 501; such gap is used for coupling of specimen chamber opening 101. FIG. 9 is a section of the cover closing the specimen chamber; under such circumstance, the specimen chamber 100 is covered by the cover 500 for screw-in; at this point, the cover is at the position A of inside the specimen chamber while the sealing element 400 is in contact with the opening 101 for sealing of the opening 101 of the specimen chamber 100. FIG. 10 is a section showing full coupling between the cover and the specimen chamber, on which, the cover 500 is at the position B inside the specimen chamber. Under such circumstance, the air inside the specimen chamber is to be compressed by the sealing element 400; whereas the gas from position A to position B inside the specimen chamber is also compressed to form certain air pressure.

The specimen processing device as provided by this invention also comprises a specimen testing chamber 300; the testing chamber 300 is communicated with the specimen chamber 100 through the fluid flow control device; in a particular embodiment, the valve chamber 206 is communicated with the testing chamber 300. The testing chamber 300 comprises a testing element 301. In an embodiment, the paper testing strip is used as the testing element 301. One or more testing elements 301 can be provided inside the testing chamber.

In a particular embodiment, the valve 200 is in “dual communication” structure; one end of the valve channel 800 leads to the specimen chamber bottom 102 for communication with the opening 107; whereas the opening on the other end as communicated with the channel 205 leads to the specimen testing chamber 300. In an embodiment, the valve is to be at the position 1 after specimens are located inside the specimen chamber 100; whereas the opening 107 of the specimen chamber bottom 102 is sealed up by valve 200. In case of pressure increase in the specimen chamber, open the opening 201 on the valve; for instance, rotate the opening; while hole B 802 is connected and communicated with specimen chamber 100 through the opening 107. As shown in FIG. 5, hole C 801 is connected with the testing chamber 300; the specimen chamber 100 as shown in FIG. 4 is communicated with the testing chamber 300 through the hole B 802, C 801 and valve channel 800; one end of the valve channel 800 and mixed buffer solution leads to the specimen chamber bottom for communication with the opening 107; forced by the increased pressure, specimens and buffer solution inside the chamber on the other end will flow into the testing chamber 300 via the communicated channel for contact with the testing element 301 to complete the test.

In a further particular embodiment, the valve is also in “tee” structure, of which, one end leads to the specimen chamber bottom 102, another end is to the specimen testing chamber 300; whereas the final end is connected with the a specimen confirmation chamber or storage chamber.

The valve is to be opened in two directions once specimens are collected inside the specimen chamber; one opening direction aims to ensure the communication between the specimen chamber 100 and the testing chamber 300 to facilitate specimens to flow into the testing chamber 300 along the opening 107 at the specimen chamber bottom 102 and the channel 800 of the valve 200 for contact with the testing element 301 to complete the test; whereas the other opening direction aims to ensure communication between the specimen chamber 100 and the confirmation chamber to facilitate fluid inside the specimen chamber 100 to flow into the storage chamber used for confirmation of the test. Nevertheless, the valve 200 can also be provided with one opening direction; fluid from the chamber 100 will flow into the valve channel 800 once the valve is opened; the valve channel also comprises two subsidiary channels; one leads to the testing chamber 300 for delivery of fluid to the testing chamber and contact with the testing element 301; whereas the other leads to the storage chamber for delivery of fluid to the storage chamber to confirm the test.

This invention also provides a box for processing of specimens to be tested, comprising a specimen process device and a specimen collection bar 700. The specimen collection bar 700 comprises a holding part 701 and an absorption element 702. The absorption element 702 can be made of materials with absorption performance, such as cotton swab, sponge and so on; such absorption element 702 can absorb solids, semi solids, liquid and even gaseous specimens. In a preferred embodiment, cotton swab serves as the absorption element 702 on the collection bar to collect saliva specimens.

In some preferred embodiments, the specimen chamber 100 of special structure can be designed to ensure more effective collection of specimens inside the specimen chamber 100 and better mixing of specimens inside the specimen chamber with the buffer solution, especially when the quantity of specimens as collected is so limited. For instance, the perforated baffle plate, the absorption part 702 of the specimen collection bar 700 can be arranged inside the specimen chamber 100 to fully discharge specimens inside it through the extrusion by the baffle plate; alternatively, it is also applicable to select specimen chamber 100 made of elastic compressible materials to discharge specimens for full mixing with the buffer solution through extrusion of the specimen chamber 100 containing the absorption element 702; in a preferred embodiment, diameter of the upper chamber part 103 of the specimen chamber 100 exceeds that of the lower chamber part 104; whereas the central part is in a tunnel structure as shown in FIG. 1; In a more preferred embodiment, height of the lower chamber part 104 can be equal to that of the cotton swab 702 on the collection bar so as to enable buffer solution inside the specimen chamber 100 to fully submerge the cotton swab 702; in this way, specimens on the cotton swab 702 are to be in full contact with the buffer solution; whereas the buffer solution can fully wash off such specimens for mutual mixing.

In an embodiment, the sealing element 400 is located on the specimen collection bar 700; specimens as collected by the collection bar 700 are to be put into the specimen chamber 100, which are to be sealed up by the sealing element 400 coming into the specimen chamber 100 simultaneously; when the collection bar 700 moves to the specimen chamber bottom 102, the sealing element 400 will also move towards the chamber bottom 102 to compress the air inside it. The sealing element 400 can be the O ring located on the specimen collection bar 700, which is kept away from the absorption element 702 and the top of the collection bar by certain distance

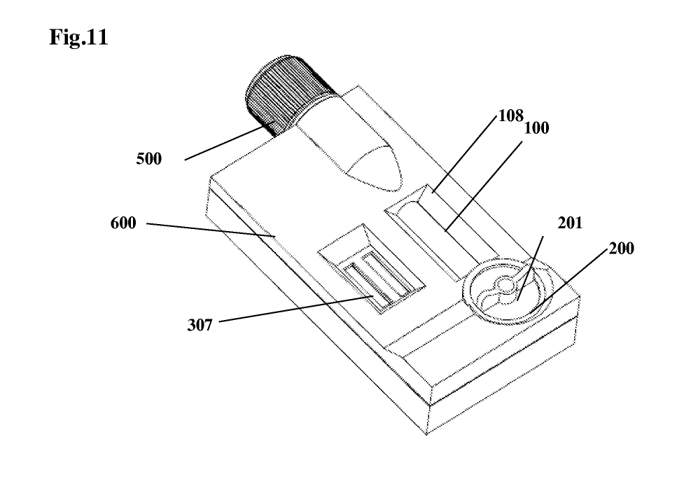

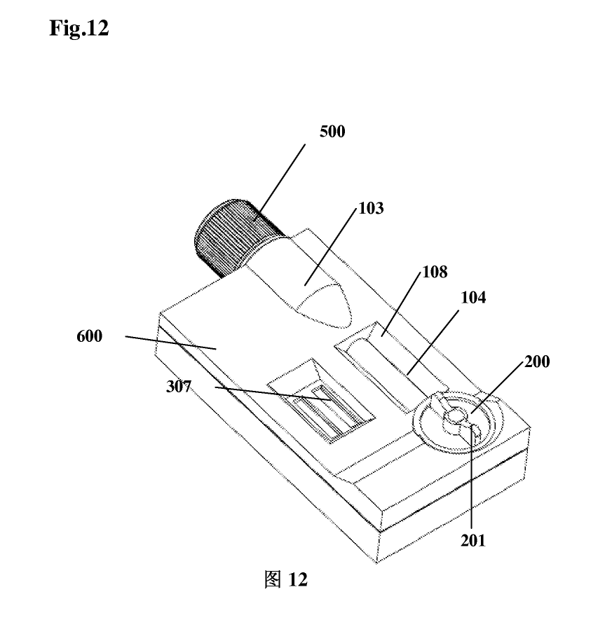

In a particular embodiment as shown in FIGS. 11 and 12, the box body 600 integrates the specimen chamber 100, the valve 200, the testing chamber 300 and the testing element 301; FIG. 13 is its structural breakdown drawing; the box body comprises a upper part 601 and a lower part 602; the specimen chamber 100 and the testing chamber 300 are located inside the box body comprising the upper part 601 and the lower part 602; the testing element 301 is located inside the testing chamber 300; the box body 600 is provided with a window 307 at the position corresponding to the result display area of the testing element 301; such window can be made of transparent material to facilitate observation of testing results; in a particular embodiment, the testing element 301 is a paper testing strip; the specimen absorption area on this testing strip is communicated with the valve 200. In particular, a channel 205 as shown in FIG. 14 is provided; one end of the channel is connected with the testing chamber 300; whereas the other end is connected with the valve chamber 206; the valve chamber 206 is further connected with the specimen chamber through the opening 107 at the specimen chamber bottom 102; meanwhile, the valve 200 inside the valve chamber 206 controls the communication between the testing chamber 300 and the specimen chamber 100; the valve 200 is provided with a switching device 201 to control the opening and closure of the valve 200, namely communication between the specimen chamber 100 and the testing chamber 300. The cover 500 at the opening 101 on one end is used to seal up the specimen chamber 100; the cover top 501 is connected with the sealing element 400. The valve 200 is at the OFF status before the specimen processing box is used; position of the valve switch is as shown in FIG. 11; under such circumstance, the hole B 802 on one end of the valve channel 800 inside the valve 200 is located at the junction of the testing chamber 300 for communication with the testing chamber; whereas the hole C 801 on the other end of the valve channel 800 is coupled with the inner wall 208 of the valve chamber 206; the valve channel 800 is not communicated with the specimen chamber 100 and the testing chamber 300; furthermore, the opening 107 on the other end of the specimen chamber 100 is sealed up by the surface 207 of the valve 200. The buffer solution is used for buffering and wash-off specimens is stored inside the specimen chamber 100 in advance before being sealed up by the cover 500.

According to one operation method, specimens are added into the specimen chamber; for instance, the specimen collection bar contacts with the patients tested for sampling; whereas the collect bar attached with specimens are to be put into the specimen chamber. The buffer solution is to be added into the specimen chamber, which can also be added before the addition of specimens. It is applicable to shake the specimen chamber for 3-5 seconds, and wait for 1-3 minutes to ensure thorough wash-off of specimens and mixing of specimens and buffer solution; open the valve connected with the opening on one end of the specimen chamber to ensure communication between the specimen chamber and the testing chamber; extrude the specimen chamber to enable mixed solution inside it to flow into the testing chamber at a high speed for contact with the testing element to complete the test.

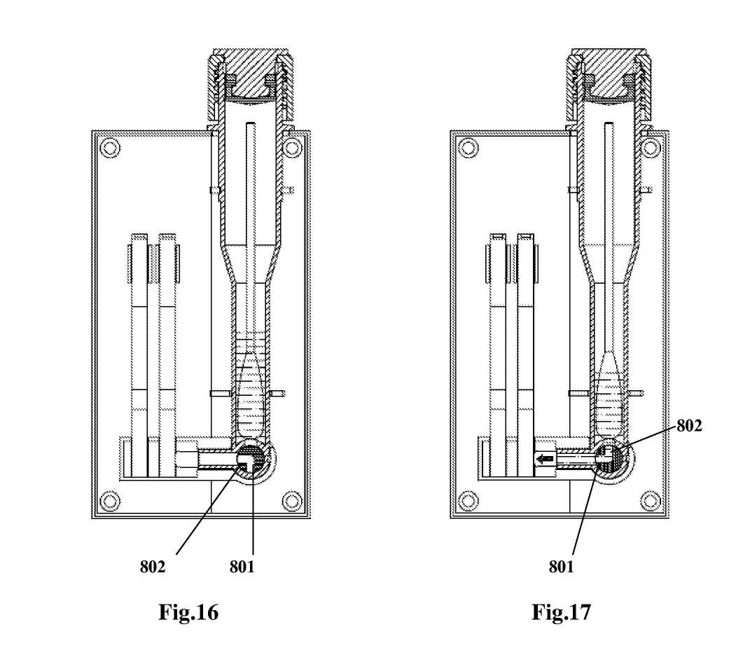

According to another operation method, the specimen collection bar 700 is to be in contact with the patients tested for sampling; for instance, it can be inserted into the mouth for collection of saliva; after that, open the cover 500 on the specimen chamber 100 as shown in FIG. 14; as shown in FIG. 15, the specimen collection bar 700 attached with specimens is to be inserted into the specimen chamber 100 to enable the cotton swab 702 on the collection bar to reach the specimen chamber bottom 102 so as to make the buffer solution submerge the cotton swab 702 on the specimen collection bar. To facilitate observation of the status specimen collection bar 700 inserted into the specimen chamber 100, it is applicable to provide a transparent observation window 108 at the position corresponding to the lower part 104 of the specimen chamber on the box body 600. After that, close the cover 500 as shown in FIG. 16 for coordinated coupling with the threads on the specimen chamber 100; under such circumstance, the air inside the specimen chamber 100 is to be sealed up and compressed by the sealing element 400 inside the cover to form a certain air pressure. To ensure adequate mixing and reaction between specimens and the buffer solution, the box body 600 is to be maintained for 2 minutes after being shaked for 10 seconds. After that, open the valve 200 as shown in the FIG. 17; under such circumstance, position of the switch 201 on the valve is as shown in FIG. 12; at this point, turn the switch to shift the opening or hole 802 on one end of the channel inside the valve 200 to the opening 107 at the specimen chamber bottom 102 for communication with the specimen chamber; whereas the hole 801 is to be switched over to the position of original hole 802 for communication with the inlet of the testing chamber 300 or the channel 205; in this way, hole C 801 is to be communicated with the specimen testing chamber 300. As a result, once the specimen chamber 100 is communicated with the testing chamber 300 through the channel 800 of the valve 200, mixed specimen solution under the action of pressure inside the specimen chamber 100 will force partial fluid to flow into the testing chamber 300 along the valve 200 for contact with the absorption area 3011 of the paper testing strip 301 for test.

To ensure equal air pressure as produced inside the specimen chamber 100, it is applicable to cover the cover body 500 on the opening 101 of the specimen chamber 100 for shift by equal distance; in this way, air pressure as produced inside the specimen chamber of different devices will be equal; consequently, the volume of fluid flowing out of the chamber under the force imposed is also identical, which can maintain the uniform and stable performance of the device. For instance, it is applicable to set the number and depth of threads inside the cover body and on the opening 101; moreover, it is also applicable to provide a projected structure 109 on the external side of the chamber opening 101 of the specimen chamber 100 to control the moving distance of the cover body 500 inside the specimen chamber opening 101.

In the event that solid or semi solid specimens are used, suspensoid will be in existence in the mixture as produced through mixing of specimens with the buffer solution. To ensure accurate testing of specimens, it is applicable to provide a filter 302 between the valve 200 and the testing chamber 300 to eliminate suspensoid as contained in the mixture, such as filter paper and strip. For instance, it is applicable to make fluids from the channel 205 flow towards the part 3011 of the testing element to be provided with specimens through the filter pad 302.

1. A device, comprising:
A specimen chamber used to collect specimens;
A fluid flow control device;
The specimen chamber is connected with the fluid flow control device;
Partial specimen chamber is made of extruding material.

2. The device according to claim 1, characterized in that extrusion of specimen chamber made of extruding material can increase pressure inside it; whereas the increased pressure will make the fluid flow out of the specimen chamber.

3. The device according to claim 2, characterized in that the said extruding material is elastic material.

4. The device according to claim 3, characterized in that the said extruding material is provided with an elastic hose.

5. The device according to claim 4, characterized in that the said extruding material is of flexible plastics.

6. The device according to claim 5, characterized in that the fluid flow control device is provided with a position 1 and a position 2; when the device is at position 1, the specimen chamber is isolated from outside; when it is at the position 2, increased pressure will make the fluid specimen flow out of the specimen chamber.

7. The device according to claim 6, characterized in that it also comprises another boosting device used to increase pressure inside the specimen chamber.

8. The device according to claim 7, characterized in that the specimen chamber comprises an opening 1 and an opening 2, wherein the opening 1 is used for coupling of the boosting device; whereas the opening 2 is connected with the fluid flow control device.

9. The device according to claim 6, characterized in that the fluid flow control device comprises a valve and a valve chamber, wherein the opening 2 of the specimen chamber is communicated with the valve.

10. The device according to claim 9, characterized in that external surface of the valve is sealed up with inner wall surface of the valve chamber through line contact.

11. The device according to claim 10, characterized in that the valve is provided with a position 1 for sealing of the opening 2 of the specimen chamber and a position 2 for opening of the opening 2 of the specimen chamber.

12. The device according to claim 11, characterized in that pressure inside the specimen chamber is to be increased when the valve is at the position 1; whereas increased pressure will make the fluid specimen flow out via the opening 2 when the valve is the position 2.

13. The device according to claim 1 comprises a testing chamber; whereas the fluid flow control device aims to control the fluid specimen flowing from the specimen chamber into the testing chamber.

14. The device according to claim 7, characterized in that another boosting device as mentioned is a sealing element.

15. The device according to claim 14, characterized in that the sealing element forms a hermetic seal with inner wall of the specimen chamber.

16. The device according to claim 15, characterized in that it comprises a cover attached with the said sealing element.

17. A device, comprising:
A specimen chamber used to collect specimens;
A fluid flow control device;
The specimen chamber is connected with the fluid flow control device;
A boosting device used to increase pressure inside the specimen chamber.

18. The device according to claim 17, characterized in that increased pressure aims to make the fluid specimen flow out of the specimen chamber.

19. The device according to claim 17, characterized in that the fluid flow control device is provided with a position 1 and a position 2; when the device is at position 1, the specimen chamber is isolated from outside; when it is at the position 2, increased pressure will make the fluid specimen flow out of the specimen chamber.

20. The device according to claim 17, characterized in that the specimen chamber comprises an opening 1 and an opening 2, wherein the opening 1 is used to collect specimens; whereas the opening 2 is connected with the fluid flow control device.

21. The device according to claim 20, characterized in that the boosting device is used to seal up opening 1 of the specimen chamber.

22. The device according to claim 20, characterized in that the fluid flow control device comprises a valve and a valve chamber, wherein the opening 2 of the specimen chamber is communicated with the valve.

23. The device according to claim 22, characterized in that external surface of the valve is sealed up with inner wall surface of the valve chamber through line contact.

24. The device according to claim 22, characterized in that the valve is provided with a position 1 for sealing of the opening 2 of the specimen chamber and a position 2 for opening the opening 2 of the specimen chamber.

25. The device according to claim 24, characterized in that the pressure inside the specimen chamber is to be increased when the valve is at the position 1; whereas increased pressure will make the fluid specimen flow out via the opening 2 when the valve is at the position 2.

26. The device according to claim 25, characterized in that the fluid specimen flowing out of the specimen chamber via the opening 2 will come into a testing chamber.

27. The device according to claim 17 comprises a testing chamber; whereas the fluid flow control device aims to control fluid specimens flowing into the testing chamber from the specimen chamber.

28. The device according to claim 17 also comprises a specimen storing chamber for test confirmation; whereas the fluid flow control device aims to control fluid specimens flowing into the storing chamber from the specimen chamber.

29. The device according to claim 17, characterized in that the boosting device is a sealing element.

30. The device according to claim 29, characterized in that the sealing element forms a hermetic seal with inner wall of the specimen chamber.

31. The device according to claim 30, characterized in that it also comprises a cover attached with the said sealing element.

32. The device according to claim 17, characterized in that the specimen chamber comprises a specimen processing reagent, namely buffer solution.

33. The device according to claim 17, characterized in that the specimen chamber is in a funnel shaped structure.

34. The device according to claim 17, characterized in that the said specimen is saliva.

35. A test kit, comprising the device according to claim 1 and the specimen collection bar.

36. The kit according to claim 35, characterized in that the said specimen collection bar comprises a specimen collection cotton swab.

37. The kit according to claim 35, characterized in that the boosting device is the sealing element attached to the specimen collection bar.
